(19) United States
(12) Patent Application Publication
(10) Pub. No.: US 2006/0041540 A1
(43) Pub. Date: Feb. 23, 2006

(54) System and Method Relating to Dynamically Constructed Addresses in Electronic Messages

(75) Inventors: Marvin Shannon, Pasadena, CA (US); Wesley Boudville, Perth (AU)

Correspondence Address: MARVIN SHANNON, 3579 EAST FOOTHILL BLVD, #328, PASADENA, CA, 91107, US

(73) Assignees: Marvin Shannon, Pasadena, CA (US); Wesley Boudville, Perth (AU)

(21) Appl. No.: 11/160,327

(22) Filed: Jun. 20, 2005

Related U.S. Application Data
(60) Provisional application No. 60/521,698, filed on Jun. 20, 2004.

(51) Int. Cl. G06F 17/30

(52) U.S. Cl. 707/3

(57) ABSTRACT

We show how a spammer can use a programming language inside an electronic message to make a dynamic hyperlink, instead of a standard static hyperlink. She can use this to obfuscate her domain, against antispam methods that extract those domains to compare against a blacklist. Plus, she can create sacrificial messages with “infinite” loops and intersperse these with her other messages, with obscured dynamic hyperlinks, but lacking infinite loops. We show how to handle both cases, to be able to extract valid hyperlinks from the latter messages and use these in the construction of, or a comparison against, a blacklist.

### TECHNICAL FIELD

This invention relates generally to information delivery and management in a computer network. More particularly, the invention relates to techniques for automatically classifying electronic

communications as bulk versus non-bulk and categorizing the same.

### BACKGROUND OF THE INVENTION

Spam often has hyperlinks to the spammer's website. So that the recipient of the spam might be induced to click on the link and then go to the website, to buy some good or service. One major method used against spam has been the extraction of domains from hyperlinks inside the body of an email. These domains are then compared against a blacklist of spammer domains. If one or more domains are in the blacklist, then the message might be treated as spam. But if this method becomes widespread amongst ISPs, then it gives incentive for a spammer to avoid her domains in hyperlinks being detected in this manner.

Our invention explains how spammers can do this, and what countermeasures can be taken against them.

### SUMMARY OF THE INVENTION

The foregoing has outlined some of the more pertinent objects and features of the present invention. These objects and features should be construed to be merely illustrative of some of the more prominent features and applications of the invention. Other beneficial results can be achieved by using the disclosed invention in a different manner or changing the invention as will be described. Thus, other objects and a fuller understanding of the invention may be had by referring to the following detailed description of the Preferred Embodiment.

We show how a spammer can use a programming language inside an electronic message to make a dynamic hyperlink, instead of a standard static hyperlink. She can use this to obfuscate her domain, against antispam methods that extract those domains to compare against a blacklist. Plus, she can create sacrificial messages with “infinite” loops and intersperse these with her other messages, with obscured dynamic hyperlinks, but lacking infinite loops. We show how to handle both cases, to be able to extract valid hyperlinks from the latter messages and use these in the construction of, or a comparison against, a blacklist.

### BRIEF DESCRIPTION OF THE DRAWINGS

There are no drawings.

### DETAILED DESCRIPTION OF THE PREFERRED EMBODIMENT

What we claim as new and desire to secure by letters patent is set forth in the following claims.

In several types of electronic communications, users are often confronted with unsolicited or unwanted messages. When these messages are email, they are commonly known as spam. Similar phenomena have also been observed in Instant Messaging (IM) and Short Message Systems (SMS). Many methods have arisen to combat these, including those advocated by us in earlier U.S. Provisional filings—#60/320,046, “System and Method for the Classification of Electronic Communications”, filed Mar. 24, 2003; #60/481,745, “System and Method for the Algorithmic Categorization and Grouping of Electronic Communications”, filed Dec. 5, 2003; #60/481,789 , “System and Method for the Algorithmic Disposition of Electronic Communications”, filed Dec. 14, 2003; #60/481,899, “Systems and Method for Advanced Statistical Categorization of Electronic Communications”, filed Jan. 15, 2004;

#60/521,014, “Systems and Method for the Correlations of Electronic Communications”, filed Feb. 5, 2004; #60/521,174, “System and Method for Finding and Using Styles in Electronic Communications”, filed Mar. 3, 2004.

In what follows, we specialize to the important case of email, to give substance to our methods. We later explain how our methods can be generalized to other Electronic Communications Modalities (ECMs).

We assume for brevity that incoming messages are received by an Internet Service Provider (ISP). In general, our statements apply to any organization that runs a message server for its members. Also, when we say “user” below, we mean the recipient of a message.

Often, unwanted messages contain hyperlinks. Typically, the user would run a special program that lets her view the message. Often, this program might be a browser. For brevity, we shall assume this below. But note that other programs might exist, that can display the message to the user. Our remarks apply to these as well. Plus, when we use “view” or “display”, we also include the cases where the user interaction might include non-visual means. For example, if the browser uses audio.

When the user views the message in a browser, and it contains hyperlinks to destinations on a computer network (usually the Internet), then she can pick (usually by clicking) the hyperlink. (We also include the case where the hyperlink is represented as a button.) Whereupon the browser either goes to that hyperlink and displays that page, or the browser makes another instance of itself, and that instance goes to the link and displays the page. Often, at the new page, by some combination of its contents and the contents of the original message, the user is urged to perform some task, by which the page's author expects to derive some benefit. Typically, this might involve the user purchasing some good or service, or by her furnishing some personal data.

In email, the hyperlinks are URLs. An example might be

“http://apple.bat.somedomain.com/bin/a?i=3”.

One way to reduce future unwanted messages is to find, by whatever means, a set of unwanted messages. From the bodies of these, the hyperlinks are extracted programmatically. Then, and this is crucial, from each hyperlink, we find the base domain. In the above example, the domain is apple.bat.somedomain.com, and the base domain is somedomain.com.

The reasoning is that the base domain is presumed to be owned by the spammer. Also, the owner can vary the arguments to the left and right of the base domain at little or no cost. Having found a set of base domains, A, we can optionally, but preferably, compare it to a set of “Exclude” domains, B. These are domains that we, for whatever reason, do not consider likely to be spammers. We remove any domains in A that are also in B. The set A is a blacklist.

Then, for future incoming messages, if any have hyperlinks with domains in A, we can treat these separately. We might reject the messages, with or without sending them back to the purported sender addresses. (These might be forged.) Or we can forward the messages to a special message folder, for each recipient. The folder might be called “Bulk”, for example. Other methods might also be used against the messages, in order to classify them.

The method of using the blacklist can have high efficacy, because a spammer has to spend time and money to maintain a website at the base domain. Nor can she obfuscate the hyperlink to her domain, because the browser must be able to go to that hyperlink, in a programmatic fashion, if the user picks it. (In our first Provisional, #60/320,046, we claimed this method.)

But suppose a spammer can in fact obscure the hyperlink, and hence its base domain? One possible way is if a programming language exists, and a program can be thusly written and put into the message. This also assumes that the browser can run that program. If so, this might be initiated from an action by the user, like picking a hyperlink or button.

Currently, at least one such language exists: Javascript. Most browsers can run Javascript programs that are in email. Other languages may also exist that can be run by a current browser. Plus, future languages and browsers may emerge, where the latter can run programs written in the former, and the programs are embedded in messages that the browsers display. Our methods also apply in these cases.

Consider Javascript. A message written in HTML can define actions to be performed when a user picks a link or button. Here is an example of a hyperlink:

<a href=“http://a.example.com”>Click here </a>

If the user picks it, the browser goes to the hyperlink explicitly written in the first tag. But with Javascript, it is possible for the tag to have an instruction to tell the browser to go to a function defined elsewhere in the message. In this function can be defined the actual hyperlink. We call this a “dynamic hyperlink”.

This term is occasionally seen elsewhere in the art, where the other context is often a customization of the hyperlink, possibly depending on some previous action by the user. That other context also does not discuss spam using such hyperlinks. Rather, it deals with how to make such hyperlinks, i.e., to be the author of documents containing these. Typically, such documents might be spreadsheets, like Excel, or documents derived dynamically from some underlying database. By contrast, anyone using our method will not be the author of a document containing dynamic hyperlinks. Instead, we discuss how spammers might use these hyperlinks, and, how to combat this.

In passing, another usage in the prior art consists of the dynamic hyperlinks being written by authors of HTML web pages, (ironically) to be used AGAINST spammers. The latter often have spiders trawl the web, to parse email addresses for their mailing lists. Some web authors write email addresses in a dynamic form, to resist a simple parsing by a spider.

We now return to the main consideration. Where a message has dynamic hyperlinks, written BY a spammer. Hence, a simple parsing of the message to search for hyperlinks, and then base domains, present in hyperlink or button tags will not reveal these domains. Or, it might find what appear to be conventional static links. But these addresses are not used, when the links are picked. They are overridden by an instruction to use (i.e. pass control to) a function. The spammer might put “good” domains in the static links, in the expectation that these will not be in the blacklist.

Thus one option for the ISP is not to compare any such base domains with a blacklist, if there are associated dynamic hyperlinks. Another option is for it to still do that comparison. The idea is that if indeed a static base domain is in a blacklist, then the ISP might choose to label the message as spam or bulk, and discontinue the steps described below. But if (as we expect) the static base domain is not in a blacklist, then we continue with our method.

It is straightforward for an antispam program to search for hyperlink or button tags that pass control to a named function, because this syntax cannot be obscured. Then, since the program has read the entire message, it can find the function, and try to extract the hyperlink from it. But the spammer can write code of essentially arbitrary complexity inside the function, and which may involve that function calling other functions, also deliberately complexly written. In the above example of a static hyperlink, it goes to “a.example.com”, where this string was explicitly written in the tag. Hence we call it a static hyperlink. Though in normal parlance, outside this Filing, this is redundant, since most hyperlinks are indeed static. In contrast, when control is passed to a function, to find a hyperlink, the string that ultimately makes up the hyperlink address can be constructed from its constituent characters in a complex fashion. Or, in more generality, the string can be assembled not just character by character, but bit by bit. Nor does this assembly have to make the string in a standard left to right manner. Subsets of the string can be made in any order.

If we choose to run the function to find the hyperlink, there is a potential danger to us. A spammer can expect us to do this. A countermeasure by her is to send a set of sacrificial messages. These do not contain any hyperlinks, static or dynamic, to her domain. And she forges the headers, so that over the entire messages' contents, there is no traceback to her. These messages have links or buttons that refer to one or more functions. But these functions are effectively infinite loops. They exist only to tie up our computers. So that hopefully, to her, we will abandon any analysis of these functions, across all incoming messages. Of course, she derives no revenue whatsoever from the messages. Hence the term ‘sacrificial’. But she might regard these as part of the cost of doing business. So that she can then send ‘real’ spam, with functions containing valid hyperlinks to her domain, that we cannot extract, because we, presumably, cannot algorithmically distinguish these from sacrificial messages that might have preceded these, or be interspersed with these, in the message stream.

What can we do? One alternative is not to run the function, but to try to analyze it. This cannot be done manually, except in unusual cases, because it is unaffordable. A spammer can easily crank out many messages that use dynamic links. Plus, the task here is far harder than just trying to identify a message as spam. A human might do this manually, and this person does not need to be a programmer. But here we are trying to extract a hyperlink from a function. The person must know the programming language and be a very skilled programmer, to try to discern what a deliberately complicated function is doing.

Another way to analyze the function is to try to write logic that does so, without actually running it. A longstanding problem in computer science. Given a computer program's source code, how can we write logic to find out what it does, aside from running it? There is no general solution to this, based on the state of the art of artificial intelligence. Existing research tends to ignore the possibility that the author of the code will actively (deliberately) write the code in a convoluted fashion, to defeat such programmatic analysis.

We provide a different method. Firstly, it is simple to programmatically detect if a message is using a function in a hyperlink or button. So we define a Style bit that is set if this happens, and unset otherwise. In our Provisional #60/521,174, we generally defined various Styles that can be used to describe a message or Bulk Message Envelope (BME). A Style is a number, often just 0 or 1, that attempts to express whether a message or BME has a certain property. So, if a message has HTML, and contains invisible text (the foreground color equals the background color), then we set a corresponding Style bit, for example.

In this Provisional, we set a Style bit if any hyperlink or button in a message uses a function. More generally, we also claim the case where this Style is a number, that varies from 0 to 1, say. This can measure the fraction of the message's hyperlinks or buttons that use functions. So that 0.5 means that half the hyperlinks or buttons use functions. We also claim any trivial related numerical measure of this Style. For example, another way might be that the Style is a non-negative integer, that counts the number of links or buttons that use functions. For the purposes of further discussion, we assume that the Style is 0 or 1. Call the Style, say, “Dynamic Hyperlink”.

Given that a message or BME has a set of Style settings, some Styles might be considered to be more indicative of spam than others. In Provisional #60/521,174, we discussed this idea at length. Here, if a message or BME has this Style (equal to 1), we might choose to regard it as very indicative of spam. The usual case of a hyperlink being a static hyperlink is common because the syntax is so simple. We might consider that a dynamic hyperlink in a message exists solely for the purpose of evading a programmatic parsing of the hyperlinks.

If so, we might choose to halt our analysis of the message, and then treat it as spam, using the above Style.

We might decide to go further. We would run the function, in the language that it was written in. To avoid any infinite loops, we can do various things. We could use two threads. A master thread could perform the analysis, until it detected a function. It then starts a slave thread to run that function. If, after a certain time has elapsed, the master finds that the slave is still running, it can assume that the function is an infinite loop, and terminate the slave.

This maximum time for the slave to run can be set arbitrarily, in relation to the link protocol, or be based on external logic. For example, keep in mind that when the user picks a hyperlink, she expects the browser to quickly go to it and display its data. At the human response time scale, one second might be reasonable. This might be a choice of the maximum time for the slave. It may actually be far too long. Most of that delay is due to the network. We can expect that a user computer runs at over 1 GHz. Additionally, the browser can be assumed to have loaded all of the message into its memory. Because nowadays, a computer's RAM is often over 100 Mb. And most messages are just a few kilobytes or less. So a function is already in memory when it is run. A 1 GHz clock corresponds to a clock cycle of 1 nanosecond. Hence, a maximum time of, say, 1 millisecond should be adequate for a long running function that takes a million clock cycles.

Instead of using two threads, we could have just one thread. It runs the function, but it also has some means of periodically evaluating how much time it has spent, and thus ending the evaluation if a threshold is exceeded.

In either case, the threshold might instead involve some extra logic, instead of it being just a constant. For example, this logic might use a set of successful previous run times to gauge what a realistic maximum allowable run time might be, for future messages. This of course assumes that an initial run used some initial constant maximum run time.

Suppose we have successfully run the function, and found the hyperlink and base domain. We can compare the latter to our blacklist. If the domain is in the blacklist, then we can treat the message as spam. Of course, we could have used the style that was set because the message had a dynamic hyperlink to do this. But an advantage of trying to run the function is that we can update our blacklist, if we wish. For example, for the domain that is in the blacklist, we might have affiliated data, like how many messages were seen with that domain, and the time of the last such message. Hence, we can update these fields, which are useful in keeping the blacklist fresh. Because suppose a domain in it has not been seen in any messages for a certain period of time, like three months. Then, we might choose to purge it from the blacklist.

But suppose running the function revealed excessive time in computing it, so that we could not extract a hyperlink? We can use this to set another Style. Call it “Infinite Loop”. The loops may not actually be infinite, but we may consider them to be so, for our purposes. Here, for this message, it can (should) be regarded as spam. But we are unable to extract a dynamic hyperlink. The setting of this Style bit can have further use. Including, but not limited to the following:

These messages might be segregated for a possible later manual scrutiny. While in general, this is not economic, as we have mentioned above, if there are only a few of these messages that make it to this level, it might be possible to manually learn more about the messages.

A possible later programmatic scrutiny. We have for these messages, a set of Styles that were extracted. These might be compared to Styles of other messages, that have Infinite Loop=0, to see if any of those messages match these, in some sense, over the other Styles. A “partial fingerprint”.

A programmatic semantic analysis. Which might include a special analysis of the writing style of the source code of the functions. This might then be compared to similar analysis of other messages, in an effort to trace the authorship of these messages.

But there is also another possible usage of the Infinite Loop Style. Instead of associating it with the message from which it was found, we might also associate it with our incoming message stream. The existence of Infinite Loop messages implies that the message stream also has messages with dynamic links that can be extracted. As discussed earlier, a spammer who sends us Infinite Loop messages would only do this if she also is sending, or will send, messages with valid dynamic hyperlinks.

Plus, the ISP might use the relay information in the messages with these Styles, to contact the mail relays that sent those messages. In general, relay information in the headers can be forged. But we know the relay that (directly) connected to us, to send us a given message. Hence if we regard some of these mail relays as uninvolved with the spammers, then we might transmit the Styles and other information upstream to them. So that they in turn might use these to block future such messages coming to them.

In essence, this is why we can and should evaluate dynamic hyperlinks, using the above precautions. Because if the dynamic hyperlinks have valid information, we can use this against our blacklist. If some messages have infinite loop dynamic hyperlinks, it tells us that other messages should have valid dynamic hyperlinks that the spammer is attempting to conceal in this fashion. Hence it is worthwhile to find that information. We use the spammer's actions against her.

Related Issues

There include, but are not limited to, the following items:

Our analysis of dynamic hyperlinks may have to be done on a non-real time basis, given the computational load issues.

The above analysis related to extracting domains and comparing against a known blacklist. It can also be used, with trivial modifications, in the finding of that blacklist. Suppose one of the ways to do that is via a user getting a message that she considers to be spam. She forwards it to her ISP, designating it as spam. The ISP then tries programmatically to extract the hyperlinks and base domains. These issues of dynamic hyperlinks and infinite loops arise here also. We can deal with them as above.

The thread that runs the functions should be run with the privileges of a typical user, or less. This is the sandbox policy used by many browsers, when running an arbitrary program inside a message. Specifically, on a unix or linux machine, the thread must not be run as root. An analogous statement can be made for a computer using a Microsoft operating system or any other operating system.

In the above, we have assumed that if a dynamic hyperlink's function can be evaluated, then in principle, all the information needed to build a hyperlink is present in the message. Of course, the hyperlink might use information that the browser makes available to the function, or which the user might already have entered into various data entry widgets in the message, or actions that the user has already performed. These might cause the function to not only produce a different hyperlink, but even a different base domain. Suppose for example, the message had two buttons, one saying “Mortgage refinancing” and one saying “Toner cartridges”. The user could only pick one of these, and one of these is picked by default. Then the user presses a button, which goes to a function. The latter returns a hyperlink with base domain mymortgage.com if “Mortgage refinancing” was pressed, and a hyperlink with base domain mytoner.com otherwise. Our methods also apply in this case. The thread that runs the function might cycle through possible user settings/actions in order to extract more information from the function. This cycling might be exhaustive or not. If the latter, we claim the case where external logic might be applied to determine what non-exhaustive testing values to use.

It is also possible that a dynamic hyperlink's function may use data and functionality that is external to the message, the browser, the user's actions and the user's computer. That is, the function may go out to locations on a network, invoke functionality there, and get resultant data, which it then uses to make the actual hyperlink. (An existing example of this functionality would be a http redirector.) If Web Services develop, then we can expect such functionality and data to be generally available on a network. Plus, we can also expect that programming languages change, or new ones arise, that can use this functionality. Specifically, one or more of these languages can be expected to be available on a browser, so that messages become more dynamic. In this instance, care has to be taken in our programmatic analysis. When the function goes out on the network, it may use an address that we can readily find, and thence resolve the base domain. But that domain should not necessarily be compared against our blacklist. It may be an innocent third party that supplies Web Services to its customers; akin to a free or paid email provider. It may not know, a priori, or condone, the spammer's activities.

Our method may also be applied against messages with suspected viruses or worms. Some of these may have the ability to connect to a network destination that is dynamically made, to elude a simple parsing of the message to extract it.

The results of running our method can also be used in other Electronic Communication Modalities. For example, if our method is used against email, and domains are successfully found from dynamic hyperlinks, then these domains, possibly converted to raw Internet Protocol addresses, might be passed to a router, in order to block incoming or outgoing communications to those addresses.

Our method might have especial importance in attacking the subset of spam commonly known as “phishing”. The authors of these fraudulent messages devote strong effort to concealing their network locations. It can be anticipated that some authors will use dynamic hyperlinks as a concealment means, regardless of whether they are trying to avoid a blacklist or not.

If the user tells her browser to turn off running the programming language in her messages, then the spammer's efforts are useless. But a spammer commonly only gets an acceptance rate of one percent or less. While this turning off will reduce her possible acceptance rate, it might be offset by her being able to evade testing of her domains against a blacklist. (Or so she thinks, in the absence of our method.) She might consider this to be an acceptable tradeoff. Plus, remember that a browser can be used to view both websites and messages. Many websites use a client side programming language. Typically, this is to do a simple validation of a form that the user might be asked to fill. The validation happens at the browser, to detect an incompleteness, without using bandwidth to send it back to the website. What is means, though, is that many users then enable that language to be run in their browsers, by default.

The existence of messages with Dynamic Hyperlink=1 or Infinite Loop=1 can be used in conjunction with the headers of those messages. For example, if these headers purport to say that the messages tend to come to us via a certain small set of relays, then we might mark those relays as suspect, as another Style bit. So that other messages that purport to come via those relays might be treated as suspect and given extra analysis, even if these messages have Dynamic Hyperlink=0 and Infinite Loop=0, for example.

Our case of email can be generalized to other ECMs. For example, a phone network is a computer network. Here, a hyperlink would be a phone number.

We now treat the case where a combination of a browser and a language within a message lets the author write dynamic text that will be visible to the recipient. In a fashion similar to the earlier discussion, a function can be used to generate text in a deliberately obscure manner. The spammer can use this to avoid many antispam techniques. These include, but are not limited to, keyword detection and Bayesians. For example, she might have conventional static text with content irrelevant to what she is actually offering. With the “real” content folded inside a function. We offer here a programmatic detection that the spammer is doing this, and we introduce a Style, called Dynamic Text, that is set if such a thing is detected, and unset otherwise. It can also be expected that a spammer might insert infinite loops into such functions, in sacrificial messages, as was discussed earlier for hyperlinks. Hence, our countermeasures to those can be applied here. In this case, we choose not to introduce a new style if such loops are discovered. Rather, we use the Infinite Loop style. Now, we define this style to be set if an infinite loop is detected, whether for hyperlink or text generation. It is simpler than having a style for each type of infinite loop, and having then to programmatically distinguish between these in a given message.

Related to the idea of a dynamic hyperlink is a method whereby a spammer writes a static hyperlink. But this goes to a redirector, which in turn points to another redirector etc. This is used to try to obfuscate her ultimate domain. But here, the ISP might merely choose to include the first and possibly later redirectors in its blacklist. This can also be done, if the spammer uses a dynamic hyperlink, where its function computes the address of a redirector, which then points to another redirector etc.

Related to the previous idea is where a spammer uses redirectors in an infinite loop. This might be from sacrificial messages, analogous to those discussed above that have the Infinite Loop Style arising out of functions in the message. Similarly, here, if we choose to follow a link, static or dynamic, then we might use a master-slave configuration, where the slave follows the link. Thus, if the slave is trapped in a loop of redirections, the master can terminate it and set a Style, “Infinite Loop Redirector”, to be associated with the message or message stream.

Domains found from dynamic hyperlinks might be reduced to base domains and these added to a blacklist. It is important to note that any base domains found from normal static link addresses should NOT be added to a blacklist, if the links also have dynamic information. Because the spammer could use the static domains as a way of contaminating a blacklist.

What is claimed is:

1. A method, when extracting a hyperlink from an electronic message, of not comparing a static domain in that link against a blacklist, if the hyperlink also has instructions to use a function to compute the link address.

2. A method of attaching a heuristic or “Style” called “Dynamic Hyperlink” to a message containing a dynamic hyperlink, and optionally using this Style to help classify the message, possibly as spam.

3. A method of evaluating a dynamic hyperlink by using a master thread or process which starts a slave thread, which then tries to compute the link's function, in order to find its address.

4. A method of using claim 3, where if the slave does not finish its computation in some time interval, the master terminates the slave, and optionally associates a Style called “Infinite Loop” with the message.

5. A method of using claim 4, where the Infinite Loop style is used to help classify the message.

6. A method of using claim 4, where if the slave does end its computation within that time interval, the base domain is found from the address and then compared against a blacklist, in order to help classify the message.

7. A method of using claim 6, where if the message is determined to be spam, by whatever means, then the base domain found by the slave is put into a blacklist, if it is not already present.

8. A method of detecting when a message has steps to use a function to compute and display text, and optionally associates a Style called “Dynamic Text” to the message.

9. A method of using claim 8, where the Dynamic Text Style is used to help classify the message.

10. A method of using claim 8, where the dynamic text is input into a Bayesian or other analysis engine, in order to help classify the message.
